(19) United States
(12) Patent Application Publication
(10) Pub. No.: US 2005/0281509 A1
(43) Pub. Date: Dec. 22, 2005

(54) Optical connector system with EMI shielding

(75) Inventors: Larry R. Cox, Austin, TX (US); Harry A. Loder, Austin, TX (US); Ching-Long Tsai, Austin, TX (US); Steven Y. Yu, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/871,406

(22) Filed: Jun. 18, 2004

(51) Int. Cl. G02B 6/38

(52) U.S. Cl. 385/59; 385/55; 385/56; 385/58; 385/60; 385/62

(57) ABSTRACT

A connector system includes an electrically conductive coupling assembly and a first optical connector assembly. The electrically conductive coupling assembly is configured for mounting in a through-opening in a panel. The first optical connector assembly is configured for engagement with the coupling assembly. The first optical connector assembly includes an electrically conductive connector body that is configured to substantially block a first interconnection opening of the coupling assembly when the first optical connector is engaged with the coupling assembly.

### BACKGROUND OF THE INVENTION

The present invention generally relates to an interconnect system for use with optical and opto-electronic systems. More particularly, the present invention relates to an optical connector system with electromagnetic interference (EMI) shielding.

In optical and opto-electronic systems, such as telecommunication networks, cabinets are utilized to accommodate optical and opto-electronic devices. Commonly, a plurality of optical, opto-electronic and electrical interconnections are formed at the cabinets. In traditional cabinet designs, the cabinet comprises a box having a front panel (or bulkhead) and a back panel (or backplane). The terms bulkhead and backplane as used in connection with the present invention refer to an interconnection plane where a multiplicity of interconnections may be made, such as with a common bus or other external device. The cabinet may also have a plurality of internal slots (also known as racks), generally parallel to each other. Components are mounted on planar substrates (commonly referred to as circuit boards or daughter cards, or simply boards or cards) which are designed to slide into the slots within the cabinet. As a card is inserted into the slots within the cabinet, mechanical, electrical and/or optical connections are formed with mating components in the cabinet.

There are at least two types of commonly used connector systems in optical and opto-electronic systems. Front panel feedthrough (or bulkhead) connector systems, and backplane feedthrough (or backplane/daughter card) connector systems. Generally, each type of optical or opto-electronic connector system consists of a connector assembly and a coupling assembly. The coupling assembly is installed on the bulkhead or backplane, and allows the optical and opto-electronic signals to be passed between connector assemblies through the bulkhead or backplane of the cabinet.

As fiber optic components/connectors are integrated into the system, they create openings through the bulkhead or backplane. The presence of a physical opening through the bulkhead or backplane of an electronic cabinet creates the potential for electromagnetic radiation leakage through the opening in the bulkhead or backplane. As the bandwidth and carrier frequencies increase, electromagnetic interference (EMI) becomes a more serious problem. Accordingly, control of EMI has arisen as an issue in optical connector system design. It is therefore desired to have an optical connector system with improved electromagnetic shielding abilities as it creates a connection through the panel of a bulkhead or backplane.

### SUMMARY OF THE INVENTION

The invention described herein provides a connector system for connecting an optical fiber through a panel. In one embodiment according to the invention, the connector system comprises an electrically conductive coupling assembly and a first optical connector assembly. The electrically conductive coupling assembly is configured for mounting in a through-opening in a panel such that the coupling assembly covers the through-opening. The coupling assembly includes a first interconnection opening. The first optical connector assembly is configured for engagement with the coupling assembly. The first optical connector assembly includes an electrically conductive connector body that is configured to substantially block the first interconnection opening of the coupling assembly when the first optical connector is engaged with the coupling assembly.

In another embodiment according to the invention, the connector system comprises an electrically conductive spacer, an electrically conductive connector housing, an electrically conductive daughter card housing, a plurality of optical connector assemblies, and a plurality of daughter card connector assemblies. The electrically conductive connector housing contains a first plurality of interconnection openings for connection with a corresponding plurality of the optical connector assemblies. The connector housing is secureable to the spacer on a first side of the spacer. The electrically conductive daughter card housing is configured for mounting on a planar substrate. The daughter card housing has a second plurality of interconnection openings for connection with a corresponding plurality of the daughter card connector assemblies, and a corresponding plurality of protrusions for releasable engagement with the spacer on a second side of the spacer. Each of the plurality of optical connector assemblies includes an electrically conductive connector body configured to substantially block a corresponding one of the plurality of interconnection openings of the connector housing.

### BRIEF DESCRIPTION OF THE DRAWINGS

FIG. 1 is a perspective view of one embodiment of a connector system according to the invention.

FIG. 2 is a perspective view of another embodiment of a connector system according to the invention.

FIG. 3 is a perspective cut-away view of the embodiment of FIG. 2 in a mated card position.

FIG. 4 is an exploded perspective view of the connector system embodiment of FIG. 2.

FIG. 5 is an exploded perspective view of an optical connector embodiment.

FIG. 6 is an exploded perspective view of the connector system embodiment of FIG. 1.

FIGS. 7 and 8 are graphs illustrating the EMI shielding capabilities of one embodiment of a connector system according to the invention.

### DESCRIPTION OF THE PREFERRED EMBODIMENTS

In the following Detailed Description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Optical connector systems according to the invention include single or multiple optical fiber systems, and generally are comprised of a conductive coupler passing through an opening in a backplane or a bulkhead, and at least one fiber optic connector adapted for connection with the coupler. The coupler and connector reduce the amount of EMI leakage through the backplane or bulkhead opening by creating a electrically conductive path between the fiber optic connector and the backplane or bulkhead. The conductive path is formed by constructing the fiber optic connector and coupler from conductive materials and integrating the individual connector and coupler components into a design that optimizes EMI shielding capabilities. Optical connector systems according to the invention may be used with cables having loose optical fibers, ribbonized optical fibers, or other types of fiber bundles.

Generally, portions of the fiber optic connector are constructed of electrically conductive materials and, when fully seated in the coupler, the connector contacts the coupler. Thus a conductive path is created around substantially the full circumference of the connector to coupler interface. In some embodiments, to further insure good electrical contact between the connector and the coupler, the connector is fitted with a conductive latch (e.g., a metallic latch) that releasably secures the connector to the coupler. Thus there is provided a conductive path between the connector, the coupler, and the latch.

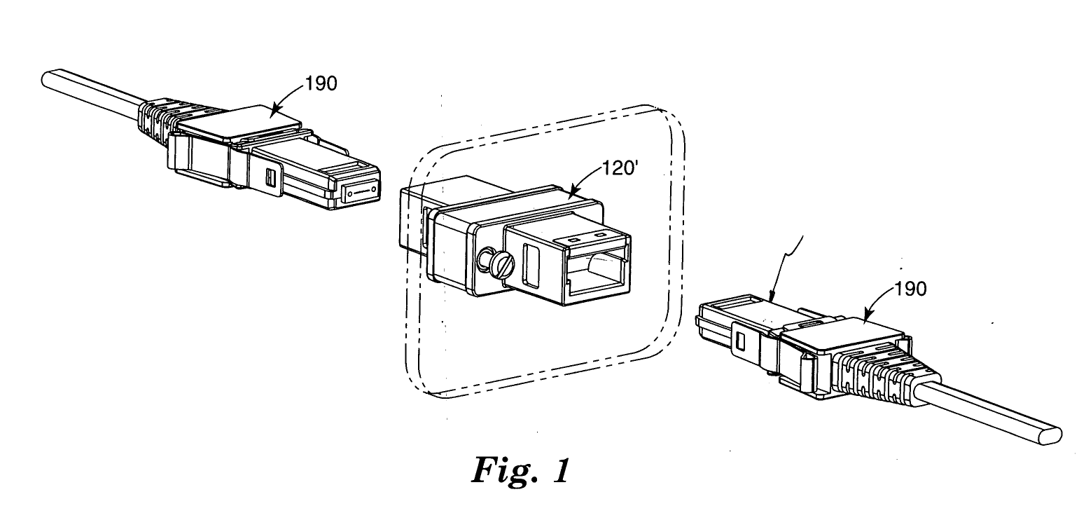

One embodiment of an optical connector system according to the invention is illustrated in FIG. 1. The optical connector system of FIG. 1 is referred to herein as a bulkhead connector system, and includes a pair of connector assemblies 190 (male and female) and a bulkhead coupling assembly 120′.

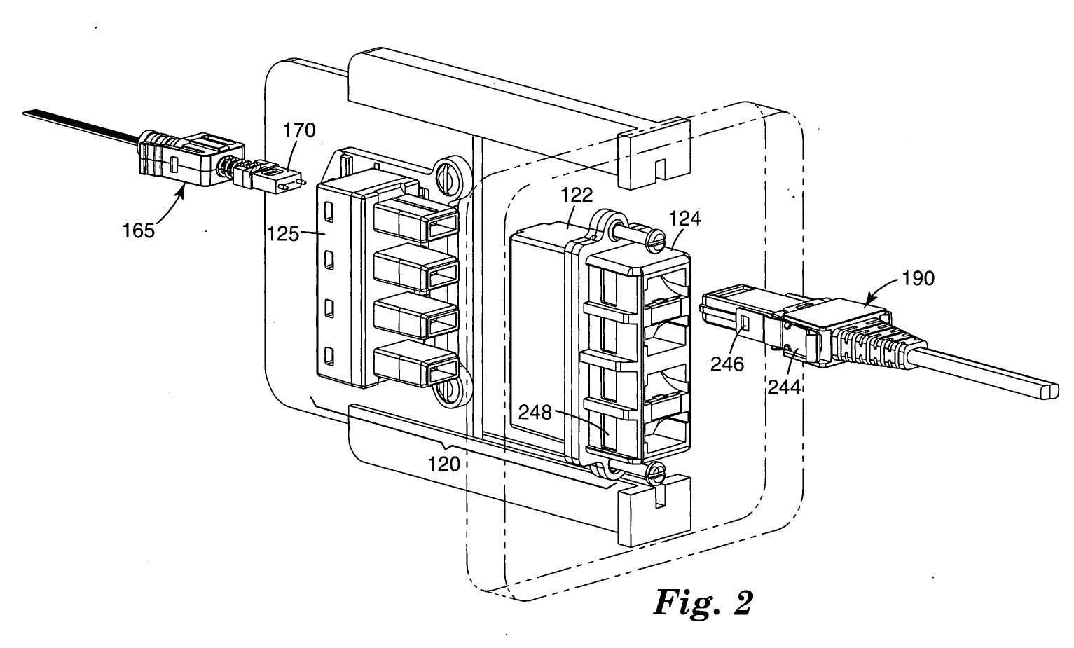

Another embodiment of an optical connector system according to the invention is illustrated in FIG. 2. The optical connector system of FIG. 2 is referred to herein as a backplane connector system, and includes a connector assembly 190, a daughter card connector assembly 165 and a backplane coupling assembly 120.

Although described herein variously as “backplane” or “bulkhead” connector systems, use of the terms backplane and bulkhead should not be construed as limiting the application of the connector systems so-described to actual cabinet backplanes or bulkheads. Rather, the connector systems described herein may be used with any panel through which it is desired to control the leakage of electromagnetic (EM) radiation.

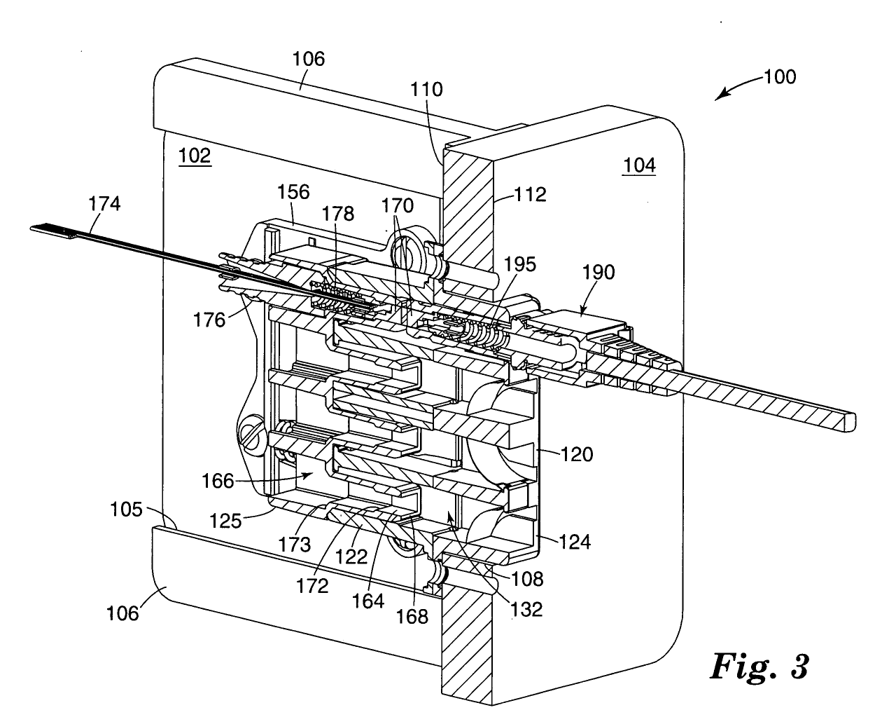

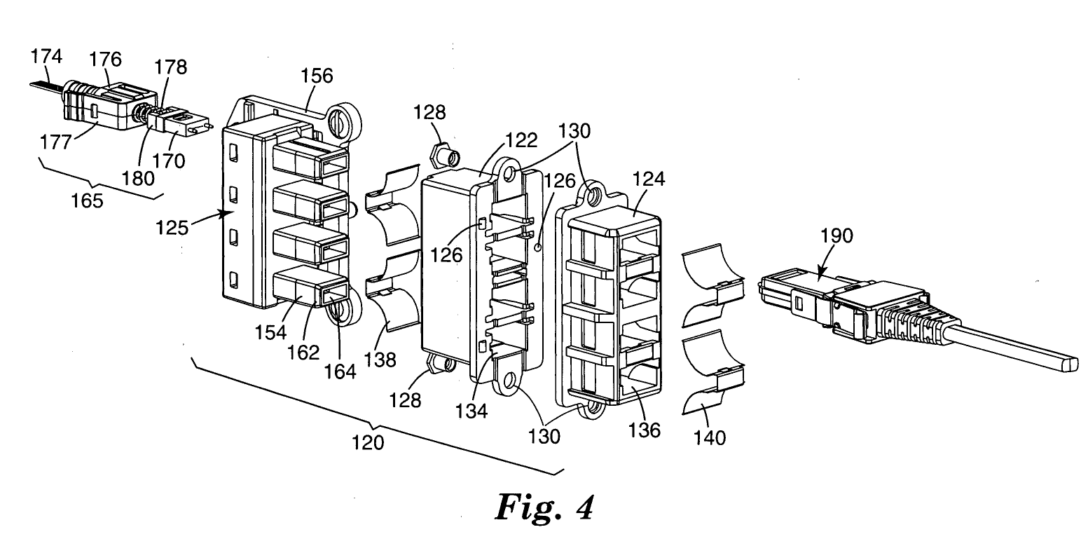

FIGS. 3 and 4 illustrate an embodiment of an optical interconnect system 100 in accordance with the present invention, and in particular the backplane connector system of FIG. 2. The optical interconnect system 100 couples a circuit card or daughter card 102 with and through a backplane 104. The card 102 is a planar substrate, such as a circuit card or daughterboard, which may include optical, optoelectronic, and electronic components. The card 102 may be slidably inserted in slots 105 defined by card guides 106. The backplane 104 includes a through-opening 108, an interior surface 110 and an exterior surface 112. In other embodiments, the optical interconnect system 100 may be used with panels other than backplanes, such as bulkheads.

The optical interconnect system 100 includes a coupling assembly 120 for insertion within opening 108. The coupling assembly 120 includes, in the illustrated embodiment, a spacer 122 (sometimes referred to as a B-housing), a connector housing 124 (sometimes referred to as an A-housing), and a daughter card housing 125 (sometimes referred to as a D-housing). The spacer 122 includes male locating features 126 that engage with corresponding female features (not shown) on a rear face of the connector housing 124. Locating features 126 help ensure accurate alignment between the spacer 122 and connector housing 124 during assembly. It should be understood that in alternative embodiments spacer 122 and connector housing 124 do not need to be separate and could be formed as a unitary piece. Separately forming spacer 122 and connector housing 124, however, may allow for more freedom in mold core design.

In the present embodiment, fasteners 128 secure spacer 122 and connector housing 124 to the backplane 104. Fasteners 128 include threaded metal inserts inserted through matching bores 130 in the spacer 122 and connector housing 124. Those skilled in the art will readily appreciate that mounting screws are used in conjunction with fasteners 128 and that a variety of fastening mechanisms, adhesives, interference fitting, and other devices known in the art may be used to align and secure the spacer 122 and connector housing 124.

The illustrated spacer 122 and connector housing 124 combine to define an array of four receiving cavities 132. Alternative embodiments may include a single receiving cavity or any other necessary number of cavities to accommodate various optical fiber cable connections. Each one of the cavities 132 includes a front opening 134 and a rear opening 136. For the purpose of the description of the present invention the terms rear, front, forward or backward are merely illustrative to help describe the depicted embodiments with respect to the figures.

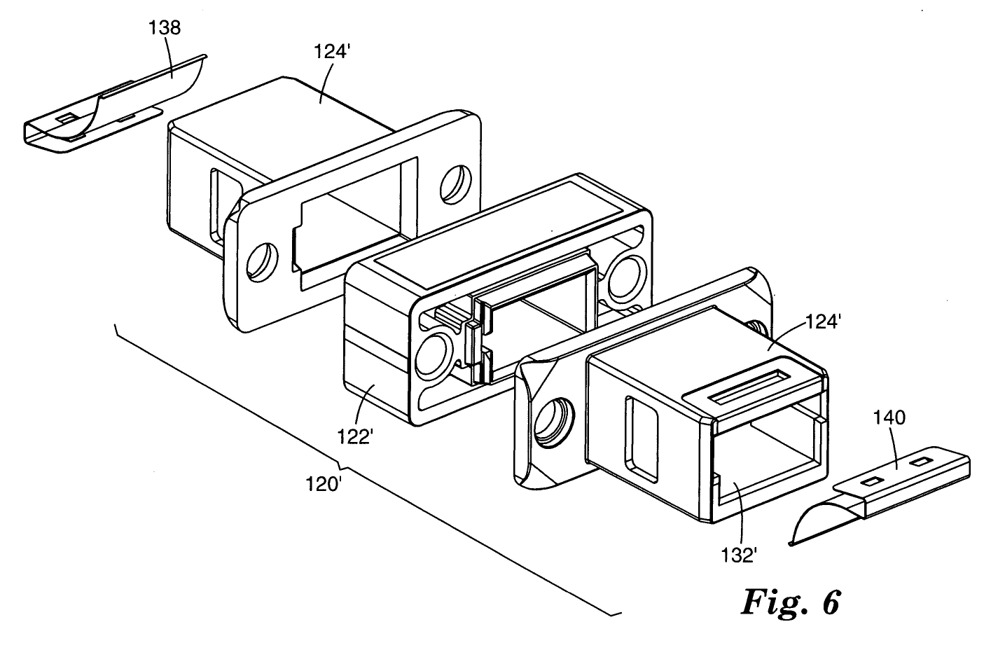

Optional folding front doors 138 are coupled to close the front opening 134 and optional rear doors 140 are coupled to close rear openings 136. In FIGS. 2-4, each door assembly covers two openings, while in FIG. 6 each door assembly covers a single opening. The doors 138 and 140 are designed to fold down flat when a connector is inserted into the opening of the receiving cavity 132. In applications where EMI protection is a concern, the front and rear doors 138, 140 may be constructed of a conductive material such as metal, and coupled to provide a grounding electrical path. Suitable metals include tempered stainless steel, beryllium/copper alloys and other materials. When made of a conductive material, the front and rear doors 138, 140 will absorb some EMI radiation that would otherwise escape through the cavities 132. In one embodiment, the front and rear doors 138 and 140 include flat spring metal members hingedly coupled to the front and rear openings 134 and 136. In embodiments where the user is not concerned with EMI, the use of doors may be optional without effecting the performance and function of the backplane housing assembly 120.

In the present invention, the backplane housing assembly 120 is electrically conductive. In one embodiment, the assembly 120 comprises molded pieces of a dielectric material that exhibit the structural strength and dimensional stability required to maintain control of the optical fiber's position. Such materials include, but are not limited to, thermoplastic injection moldable polymers that are filled or unfilled with reinforcement agents, and transfer moldable polymers such as epoxy. The dielectric material is then coated or plated with a layer of conductive material over the entire surface. In one embodiment, the dielectric material is polyetherimide and the conductive layer is nickel or an alloy thereof, such as a nickel-phosphorous (Ni—P) alloy. The thickness of the conductive layer is in the range of about 2 microns. In other embodiments, the backplane housing assembly 120 may be formed of other conductive materials, such as metals or conductive polymers.

The spacer 122 mates with a daughter card housing 125, including hollow protrusions 154 shaped in size to correspond and fit into front openings 134 of the spacer 122. The daughter card housing 125 includes board attachment features 156 that secure the daughter card housing 125 to the board. Those skilled in the art will be readily aware of additional and various methods for attaching the daughter card housing 125 to the planar substrate 102. Alternative embodiments may include attachment means such as mechanical fasteners, spring clips or the like, and may fix daughter card housing 125 relative to planar substrate 102, or alternately allow some relative movement between daughter card housing 125 and planar substrate 102. Possible attachment means allowing relative movement between daughter card housing 125 and card 102 are described in U.S. patent application Ser. No. 10/685,149, filed Oct. 14, 2003, titled “Optical and Opto-electronic Interconnect Alignment System”, and U.S. Pat. No. 6,419,399, issued Jul. 16, 2002, titled “Optical Fiber Connector Systems”, both of which are hereby incorporated herein by reference in their entirety. The range of motion of the daughter card housing 125 with respect to the card 102 is preferably sufficient to correct for tolerance errors in the range of movement of the card 102 along the card guides 106, and to absorb any excessive force imparted by the user when inserting the card 102 before the card 102 is stopped by the spacer 122 or by any stop features (if present) in the card guides 106. Accordingly, in the coupled position, the daughter card housing 125 is held tightly against the back of the spacer 122 to ensure that intimate contact is maintained between the daughter card housing 125 and spacer 122, even in the event that the card 102 is subject to movement during its operation.

The protrusions 154 in the present embodiment are hollow and rectangular shaped and are terminated in a truncated pyramid shaped lead 162. The pyramid shaped lead 162 allow for compensation of certain mating misalignments by directing the board housing assembly protrusions 154 into the receiving cavities 132. Furthermore, the protrusions 154 are shaped to provide alignment with respect to the inside walls of receiving cavities 132. Protrusions 154 also provide an automatic pressure for opening front doors 138 during mating (if present). The inner walls of protrusion 154 define a stepped cavity 164 that provides guidance to a fiber optic ferrule 170 to be seated inside of the stepped cavity 164.

In the present embodiment, the stepped cavity 164 is shaped to receive a daughter card connector assembly 165 having an industry standard ferrule 170, such as the MT-style optical ferrules. Step cavity 164 is designed in such a manner that it comprises a front and a rear rectangular opening 166 and 168, respectively. The front opening 166 is sized to allow insertion of the ferrule 170 up to an internal flange 172. A typical MT-style connector includes a ferrule 170 mounted on a stalk of optical fibers 174, slidably connected to a détente body portion 176. The ferrule 170 has a limited range of motion along the longitudinal axis. The stalk of optical fibers 174 is allowed to move with respect to the détente body portion 176. A spring element located between the ferrule and the détente body portion forward biases the ferrule towards a forward end of the range of motion.

In the present embodiment, the daughter card housing 125 includes step cavity 164 designed to accept the MT connector 165, including the détente body portion 176. The détente body portion 176 is retained against flange 173 while the ferrule 170 is allowed to extend inside of protrusion 154 up to and through the rear opening 168. The détente member 176 is designed in such a manner that as the member 176 is inserted into the front of the stepped cavity 164, the spring 178 is compressed between détente member 176 and the ferrule 170. The ferrule 170 is prevented from traveling freely through the rear opening 168 by a flange 180 formed in the ferrule 170. The flange 180 is formed to act as a travel stop for the ferrule 170 when flange 180 is engaged with internal flange 172. The détente member 176 is provided with a latch feature 177 that engages the front opening 166 of the daughter card housing 125. Preferably, latching features 177 are provided on both side surfaces of the détente member 176. Preferably, latch feature 177 is cantilevered and allowed to pivot, thereby allowing the latch feature 177 to be sprung inwards to release from daughter card housing 125.

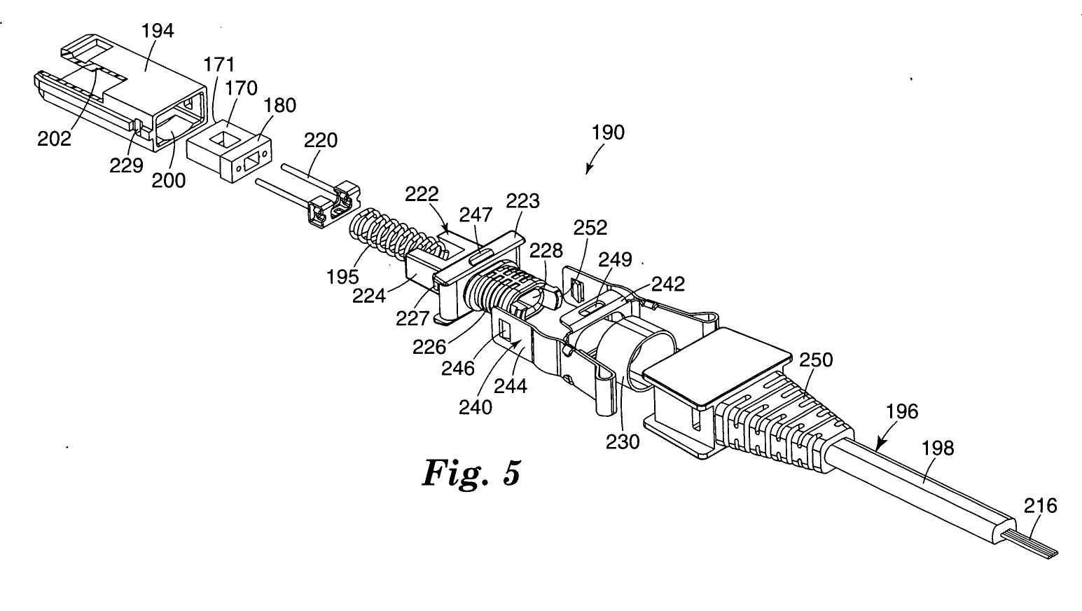

FIG. 5 illustrates an exploded optical connector assembly 190. The optical connector assembly 190 provides connectorization features to match the coupling assembly 120, and is described with respect to the conventional MT-style connector ferrule 170 as described above. Those skilled in the art will readily appreciate that the optical connector assembly 190 may be adapted for use with different types of connector ferrules.

The optical connector assembly 190 includes a ferrule 170 for terminating one or more optical fibers of an optical fiber cable 196 that is surrounded by a protective jacket 198. The optical connector assembly 190 further includes a ferrule housing 194, ferrule spring 195, spacer element 220, body 222 with engagement portion 224 and clamping portion 226, crimp ring 230, latch mechanism 240, and resilient strain relief boot 250.

The ferrule housing 194 (sometimes referred to as an “F-housing”) is configured to slidably receive the ferrule 170 therein. The ferrule housing 194 includes a passage 200 extending therethrough. Flange surfaces 202 are provided within passage 200. The ferrule 170 has a front portion 171 and a flange 180. The front portion 171 passes freely through passage 200, including past flange surfaces 202. However, passage 200 and flange surfaces 202 are sized such that the flange 180 is too large to move past flange surfaces 202. Instead, the flange 180 of ferrule 170 rests against the flange surfaces 202 when ferrule 170 is in its fully forward position.

Connector body 222 includes a central portion 223 having engagement portion 224 and clamping portion 226 extending in opposite directions from central portion 223. A passage 228 extends through engagement portion 224, central portion 223 and clamping portion 226 for the passage of optical fibers. Passage 228 is preferably of a size no larger than required to allow passage of optical fibers, thereby minimizing EMI leakage through passage 228.

Engagement portion 224 is configured to engage and be securely retained within passage 200 of ferrule housing 194, such as by the cooperative engagement of protrusions 227 on engagement portion 224 with openings 229 in ferrule housing 194. When ferrule spring 195 and connector body 222 are assembled with ferrule housing 194, the ferrule spring 195 is compressed between flange 180 of ferrule 170 and the connector body 222. The compression of ferrule spring 195 results in a force being exerted against flange 180 and connector body 222, therein spring biasing ferrule 170 forward through opening 200.

Clamping portion 226 provides a surface against which a clamp or crimp ring 230 may be used to secure strength members 216 of fiber optic cable 196. The strength members 216 are generally present in fiber optic cables and are typically attached to fiber optic connectors to relieve axial stress on the cable's optical fibers. Clamping portion 226 may be provided with ridges or similar features to aid in securing strength members 216.

Latch mechanism 240 is secured to connector body 222 and provides releasable engagement between the optical connector assembly 190 and the coupling assembly 120. Latch mechanism 240 includes a mating portion 242 for securing to connector body 222, and resiliently deflecting latch arms 244 for engagement with coupling assembly 120. Latch arms 244 include catch members 246 configured to securely engage with recesses 248 (shown in FIG. 2) in coupling assembly 120. Latch mechanism 240 may be secured to central portion 223 of connector body 222 such as by the cooperative engagement of protrusions 247 on central portion 223 and openings 249 in mating portion 242 of latch mechanism 240. In the illustrated embodiment, mating portion 242 of latch mechanism 240 includes a cutout area such that mating portion 242 may slide over clamping portion 226 of connector body 222. In the illustrated embodiment, the latch mechanism 240 is mounted on the outside surfaces of the connector body 222 and contacts the outside of connector housing 124 to prevent interruption of the internal coupler-to-connector interface. In other embodiments, latch mechanism 240 may be configured to make contact on other portions of connector housing 124, including internal surfaces thereof.

Strain relief boot 250 is formed of a flexible and resilient material, such that boot 250 controls or limits the mechanical strain due to bending of the optical fibers as the cable exits optical connector assembly 190. In the illustrated embodiment, strain relief boot 250 is removably secured to connector body 222 by press fitting boot 250 over crimp ring 230 and clamping portion 226, and also by engagement with protrusions 252 extending from clamping portion 226. In alternate embodiments strain relief boot 250 may be secured by press-fit alone, by engagement with protrusions 252 or the like, or in another suitable manner. If permanent attachment is desired, adhesive or the like may be used.

In other embodiments of the invention, such as shown in FIGS. 1 and 6, connector assemblies 190 may be used on both sides of coupling assembly 120′. In such embodiments, connector housings 124′ are provided on both sides of spacer 122′. The spacer 122′ and connector housings 124′ may provide one or more receiving cavities 132′, as is required for a particular application.

The EMI shielding ability of this invention can be further enhanced by increasing the length of the conductive path passing through the backplane or bulkhead. In the simplest form this would mean increasing the thickness of the connector housing 124, 124′ or spacer 122, 122′. Increasing the connector housing thickness (increasing the dimension in the direction moving from the front of the backplane/bulkhead to the rear would lengthen the conductive path and create a frequency cutoff effect, thus limiting the amount of EMI energy that can be radiated.

In embodiments of the present invention, the electrically conductive components, including spacers 122, 122′, connector housings 124, 124′, daughter card housings 125, connector bodies 222, ferrule housings 194 and latch mechanisms 240 are formed of suitable conductive materials. Suitable materials include dielectric materials that exhibit the structural strength and dimensional stability required for the particular components which are plated with a conductive layer. Suitable dielectric materials include, but are not limited to, thermoplastic injection moldable polymers that are filled or unfilled with reinforcement agents, and transfer moldable polymers such as epoxy. In one embodiment, the dielectric material is polyetherimide. In one embodiment, the conductive layer is nickel or an alloy thereof, such as a nickel-phosphorous (Ni—P) alloy, applied in a conventional deposition process. The thickness of the conductive layer is in the range of about 2 microns. In other embodiments, the conductive components are formed of other conductive materials, such as metals or conductive polymers.

### EXAMPLES

The improved EMI shielding provided by an optical connector system according to the invention is illustrated in the following example.

A bulkhead optical connector system, as illustrated in FIG. 1, having a standard ferrule housing and coupler spacer made of polyetherimide (ULTEM 2300) was provided. The ferrule housing and coupler spacer were formed of a dielectric material and made electrically conductive by depositing on the surface thereof a thin layer of Ni—P alloy layer using a conventional electroless nickel deposition process. The thickness of the Ni—P layer on the ferrule housing and coupler spacer was about 2 microns.

To measure the effectiveness of the optical connector system in reducing EMI, a microwave transmitter was set up in one room and a microwave receiver was installed in an adjacent room. The connector system under test was mounted in a panel cutout in the wall separating the microwave transmitter and receiver. Preliminary measurements taken with the long axis of the panel cutout in both vertical and horizontal orientations showed that the radiation was stronger in the vertical orientation. Therefore, the results for the vertical orientation are presented and discussed herein.

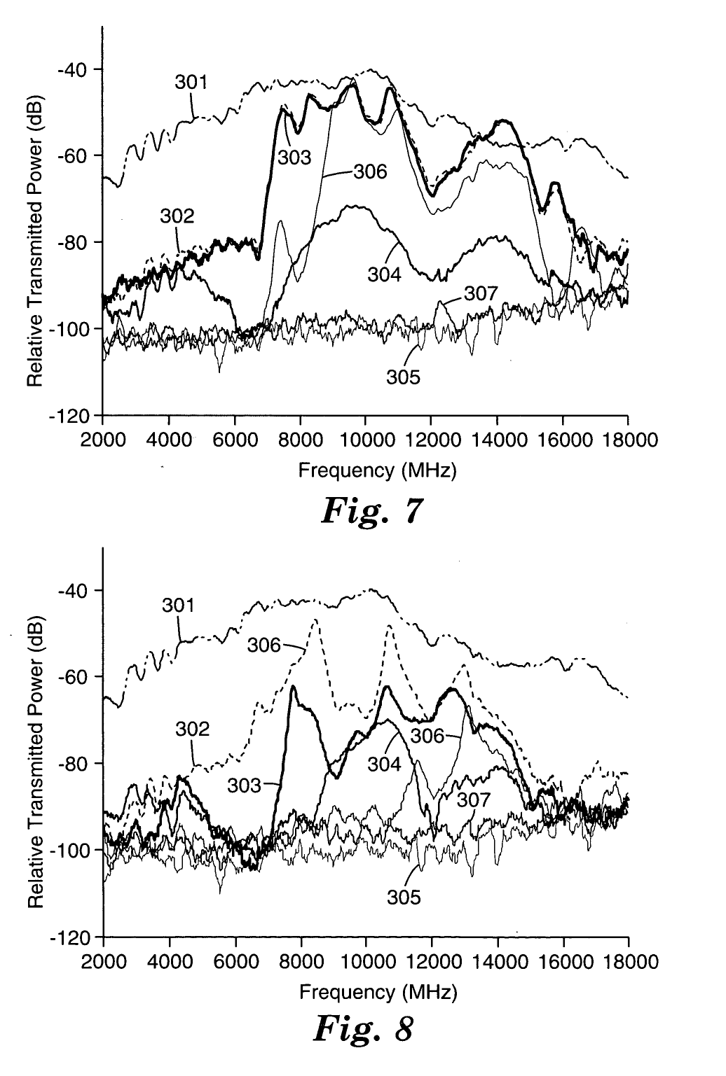

FIG. 7 shows the results of an EMI investigation for the vertical orientation with connectors populating both sides of the coupler.

Curve 301 in FIG. 7 shows the spectrum of EM radiation transmitted through the open cutout (that was used to hold the optical connector assembly) as a function of frequency from 2 GHz to 18 GHz. In this particular case, the radiation transmission power ranges from about −40 dB to about −75 dB. Curve 301 is used as the reference for the maximum power “leakage”.

Curve 302 and curve 303 are the spectra for the leaking EM radiation when a control connector assembly (having a plastic ferrule housing and plastic coupler spacer) is installed in the panel cutout. Curve 302 shows the EM radiation when the coupler is installed without a Ni/Cu gasket, while curve 303 shows the EM radiation when the coupling assembly is installed with a Ni/Cu gasket. For curves 302 and 303, the radiation transmission power ranges from about −90 dB to −40 dB. It is apparent that the control connector assembly is effective in EMI shielding in the range from about 2 GHz to about 7 GHz. The small difference between curves 302 and 303 indicates that the presence of the Ni/Cu gasket makes negligible difference in EMI shielding provided by the coupling assembly.

Curve 304 shows the relative transmitted power radiation when only the ferrule housing is coated with a Ni—P layer having a thickness of approximately 2 um. It is evident from curve 304 that the EMI shielding is effective for frequencies from about 2 GHz to about 18 GHz. The shielding factor is more than 30 dB across this frequency range, but there is about 20 dB to 30 dB of radiation leaking through the connector assembly.

Curve 305 is the measurement noise floor that ranges from about −90 dB at the high end of the measured frequency range to about −100 dB at the low end of the measured frequency range. Curve 305 is also used as a reference for this investigation. The difference between curve 301 and curve 305 is the “net” EM power transmission through the open cutout.

Curve 306 shows the result of the EMI shielding for the assembly that includes a plastic ferrule housing and a metal-coated spacer.

Curve 307 is the result of the spectra for radiation leaking through an assembly that includes a metal-coated ferrule housing and also a metal-coated coupler spacer. The spectrum of curve 307 is nearly identical to curve 305, the noise floor of this measurement setup.

Examining the curves of FIG. 7, it can be seen that the power transmission spectrum using connector system with metal-coated ferrule housing and a standard spacer (curve 304) or plastic ferrule housing and a metal-coated spacer (curve 306) is typically higher than the power transmission spectrum using a metal-coated ferrule housing and also a metal-coated coupler spacer (curve 307). It is therefore apparent that the EMI shielding for the connector system with a metal-coated ferrule housing and a metal-coated coupler spacer is better than those systems with either only a metal-coated ferrule housing (curve 304) or with only a metal-coated coupler spacer (curve 306).

FIG. 8 shows the results for the EMI shielding for the connector system with connector assemblies populated on only one side. Unsurprisingly, the connector systems with only one side populated (FIG. 8) behave similarly to the connector systems with both sides populated (FIG. 7).

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the mechanical, electrical, and optical arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

1. A connector system for connecting an optical fiber through a panel, the connector system comprising:
an electrically conductive coupling assembly configured for mounting in a through-opening in a panel such that the coupling assembly covers the through-opening, the coupling assembly including a first interconnection opening; and
a first optical connector assembly configured for engagement with the coupling assembly, the first optical connector assembly including an electrically conductive connector body, the connector body configured to substantially block the first interconnection opening of the coupling assembly when the first optical connector is engaged with the coupling assembly such that a conductive path is created around substantially the full circumference of the connector to coupler interface.

2. The connector system of claim 1, further comprising an electrically conductive latch configured for releasably securing the connector body to the coupling assembly and establishing an electrical path between the connector body and the coupling assembly.

3. The connector system of claim 2, wherein the latch contacts an outside surface of the coupling assembly.

4. The connector system of claim 1, wherein the first optical connector assembly is configured for termination of an optical fiber ribbon cable.

5. The connector system of claim 1, further comprising:
a second optical connector assembly including an electrically conductive connector body, the connector body configured to substantially block a second interconnection opening of the coupling assembly.

6. The connector system of claim 5, wherein the first interconnection opening is positioned on a first side of the coupling and the second interconnection opening is positioned on a second side of the coupling assembly.

7. The connector system of claim 6, wherein the first and second interconnection openings are axially aligned with each other.

8. The connector system of claim 5, wherein the first and second interconnection openings are positioned on a first side of the coupling assembly.

9. The connector system of claim 1, wherein the first optical connector assembly further comprises:
a ferrule for terminating an optical fiber; and
a ferrule housing having a passage configured for slidably retaining the ferrule therein.

10. The connector system of claim 9, wherein the ferrule housing is electrically conductive.

11. The connector system of claim 1, wherein the coupling assembly comprises:
an electrically conductive spacer;
a first connector housing containing the first interconnection opening and securable to the spacer on a first side of the spacer.

12. The connector system of claim 11, wherein the coupling assembly further comprises:
a second connector housing containing a second interconnection opening and securable to the spacer on a second side of the spacer.

13. The connector system of claim 1, further comprising:
a daughter card optical connector assembly configured to substantially block a second interconnection opening of the coupling assembly.

14. The connector system of claim 13, wherein the coupling assembly comprises:
an electrically conductive spacer;
an electrically conductive connector housing containing the first interconnection opening and secureable to the spacer on a first side of the spacer; and
an electrically conductive daughter card housing for mounting to a planar substrate, the daughter card housing having a second interconnection opening configured for receiving the daughter card connector assembly and a protrusion configured for engagement with the spacer on a second side of the spacer.

15. The connector system of claim 1, wherein the connector body is configured to establish a conductive path around the periphery of the interconnection opening.

16. The connector system of claim 1, wherein the coupling assembly is in electrical contact with the panel.

17. The connector system of claim 1, wherein the connector body is formed of a metal.

18. The connector system of claim 1, wherein at least one of the coupling assembly and connector body is formed of a dielectric material coated with a conductive layer.

19. A connector system for connecting an optical fiber through a panel, the connector system comprising:
an electrically conductive spacer;
an electrically conductive connector housing containing a first plurality of interconnection openings for connection with a corresponding plurality of optical connector assemblies, the connector housing secureable to the spacer on a first side of the spacer;
an electrically conductive daughter card housing for mounting on a planar substrate, the daughter card housing having a second plurality of interconnection openings for connection with a corresponding plurality of daughter card connector assemblies, and a corresponding plurality of protrusions for releasable engagement with the spacer on a second side of the spacer;
wherein each of the plurality of optical connector assemblies includes an electrically conductive connector body configured to substantially block a corresponding one of the plurality of interconnection openings of the connector housing such that a conductive path is created around substantially the full circumference of the connector to coupler interface.

20. The connector system of claim 19, wherein each of the connector bodies and connector housings are configured to establish a conductive path around substantially the full periphery of the interconnection openings.

21. The connector system of claim 19, wherein each of the daughter card connector assemblies includes an electrically conductive body portion configured to engage and substantially block a corresponding one of the plurality of interconnection openings of the daughter card housing.

22. The connector system of claim 19, wherein each of the plurality of optical connector assemblies further comprises a conductive latch engaged with the connector body, the conductive latch configured to releasably engage the connector housing.

23. The connector system of claim 22, wherein a conductive path is established between the connector body, the connector housing, and the latch.

24. The connector system of claim 22, wherein the latch releasably engages an outside surface of the connector housing.

25. The connector system of claim 22, wherein the connector housing, connector body, and latch are plated with a layer of metal.

26. The connector system of claim 19, wherein the connector housing is in intimate contact with the panel.

27. The connector system of claim 19, wherein the optical connector assembly further comprises a conductive ferrule housing.

28. The connector system of claim 19, wherein at least one of the spacer, connector housing, daughter card housing, and connector body is formed of a dielectric material coated with a conductive layer.

29. The connector system of claim 28, wherein the dielectric material is polyetherimide and the conductive layer is nickel or an alloy thereof.

30. The connector system of claim 29, wherein a thickness of the conductive layer is about 2 microns.

31. A method for connecting an optical fiber through a panel, the method comprising:
mounting an electrically conductive coupling assembly in a through-opening in a panel such that the coupling assembly covers the through-opening, the coupling assembly including a first interconnection opening; and
engaging an electrically conductive first optical connector assembly with the electrically conductive coupling assembly, the first optical connector assembly configured to substantially block the first interconnection opening of the coupling assembly when the first optical connector is engaged with the coupling assembly such that a conductive path is created around substantially the full circumference of the connector to coupler interface.

32. The method of claim 31, wherein engaging the electrically conductive first optical connector assembly with the electrically conductive coupling assembly comprises forming a mechanical and an electrical contact between the first connector assembly and the coupling assembly.

33. The method of claim 32, wherein forming a mechanical and an electrical contact between the first connector assembly and the coupling assembly comprises engaging an electrically conductive latch on the first connector assembly with the coupling assembly.

34. The method of claim 31, further comprising:
engaging an electrically conductive second optical connector assembly with the electrically conductive coupling assembly, the second optical connector assembly configured to substantially block a second interconnection opening of the coupling assembly.

35. The method of claim 32, wherein forming an electrical contact between the first connector assembly and the coupling assembly comprises establishing a conductive path around the periphery of the interconnection opening.

36. The method of claim 31, wherein mounting an electrically conductive coupling assembly in a through-opening in a panel comprises electrically connecting the coupling assembly with the panel.
